(19) United States
(12) Patent Application Publication
(10) Pub. No.: US 2005/0018095 A1
(43) Pub. Date: Jan. 27, 2005

(54) Glasses and classes lenses for stereoscopic image and system using the same

(76) Inventor: Han-Sik Kim, Seoul (KR)

Correspondence Address: GREENBLUM & BERNSTEIN, P.L.C., 1950 ROLAND CLARKE PLACE, RESTON, VA, 20191, US

(21) Appl. No.: 10/502,046

(22) PCT Filed: Aug. 16, 2002
(86) PCT No.: PCT/KR02/01557

(30) Foreign Application Priority Data
Jan. 30, 2002 (KR) 2002/5329
Jan. 30, 2002 (KR) 2002/5330
Jan. 30, 2002 (KR) 2002/5331
Jan. 30, 2002 (KR) 2002/5332

(51) Int. Cl. G02F 1/1335

(52) U.S. Cl. 349/13

(57) ABSTRACT

Glasses lenses for stereoscopic image and glasses using the same relates to a liquid crystal layer with flexible films formed on transparent electrode. This invention makes the lenses flexible, and by bending the lenses, fashionable glasses can be made. In this invention, the glasses' breakage has decreased because the film's material is unbreakable by impact and the viewer wearing the glasses is comfortable because of thin thickness and lightweight. Also, the glasses for stereoscopic image are equipped with a connector holder. Thus, in case of cable malfunction, a user only needs to change the cable, not the whole unit.

### TECHNICAL FIELD

This invention relates to glasses, glasses lens for stereoscopic image, and system using the same. In particular, this invention relates to glasses lens for stereoscopic image and glasses for the same. In detail, this invention provides a pair of fashionable glasses, strong and comfortable for wearing, composed of flexible lens to form liquid crystal layer with flexible transparent film layer on transparent electrode. Also, this invention relates to glasses lens and glasses for stereoscopic image equipped with a connecting holder. Thus, a user may simply change the cable only in case of a mal-function of cable operation. And this invention relates to a system and a method for controlling shutter function of glasses for stereoscopic image by wireless communications.

### BACKGROUND ART

In development of the 3-dimensional image, the polarization method was developed in 1920's, the optical hologram method was developed in 1948, and the broadcast services using various stereoscopy has been studied. At present, the three-dimensional games as well as the stereoscopy broadcast are gradually expanding along with the beginning of the digital age.

Upon wearing the glasses to selectively receive the stereoscopic image signals, a viewer can feel the stereoscopic image. It is known that left and right eyes are actually accepting different images respectively, and the viewer feels the stereoscopic images by analyzing them in the brain. According to the above-mentioned description the factor to recognize the three-dimensional space is caused to be incident into the left and the right eye. Therefore, taking two images are needed to realize the stereoscopic image.

Thus, the stereoscopic image is obtained when the image is taken a picture by at least two stereoscopic image cameras, then the image is separated and transmitted into the display. The viewer wears the glasses to watch selective image respectively with left and right eyes as the glasses with the shutter carries out the switching operations of the displayed image to make the viewer feel the stereoscopic image.

FIG. 1a and FIG. 1b are cross sectional diagrams explaining the principle of a shutter function of the glasses. As it is shown in the diagrams, the glasses lens has a liquid crystal layer between the upper and the lower electrodes 11 and 10. The upper transparent glass 15a, lower transparent glass 15b and the upper and lower polarizer 16 and 17 are successively formed. The upper and lower electrode 11 and 10 are contacted with power supply voltage 20.

In this glasses lens for the stereoscopic image, the stereoscopic image light is incident along with the upper polarizer 16 and goes into the liquid crystal layer 13 through the transparent glass 15a and 15b.

At this time, the liquid crystal layer 13 makes the stereoscopic image light go straight or turn at 90 degrees, in response to the provision of the amount of the power supply voltage into the upper and the lower electrode 11 and 10.

As shown in FIG. 1a, if the predetermined voltage from power supply 20 is not applied to the upper and the lower electrodes 11 and 10, then the stereoscopic image light incident into the upper polarizer 16 of the lens is turned 90 degrees owing to the twisted liquid crystal molecules of the liquid crystal layer 13.

If the stereoscopic image light is turned 90 degrees, it is in a perpendicular position to polarization surface of the polarizer 17 and cannot go trough the lower polarizer 17. Therefore, the incident light is blocked when a predetermined power supply voltage 20 is not applied to the upper and the lower electrodes 11 and 10. This is a shutter function of the glasses for stereoscopic image. At this time the viewer cannot watch stereoscopic image.

And as shown in FIG. 1b, if the voltage is applied to the upper and lower electrodes 11 and 10, it transmits the incident light into liquid crystal layer and is emitted through the polarizer 17. So the viewer can watch the stereoscopic image.

This shutter function in the glasses for stereoscopic image operates about 120 times per second depending on the types of stereoscopic image.

In FIG. 2, which shows a cross-sectional view of prior art glasses for stereoscopic image, the liquid crystal layer is formed between the upper and lower electrodes 31 and 32 and a successive formation of the transparent glasses 33 and 34 and the polarizer 35 are respectively made on the upper part of the upper electrode 31 and the lower part of the lower electrode 32. As the glasses lenses for stereoscopic image mentioned above, the materials to cover liquid crystal layer are the transparent glass in square shape, and as shown the FIG. 3, in actual case of producing glasses 105, the thick housing 110 is required. These glasses of prior art make the viewer feel fatigue due to the heavy weight of the glasses and the thick housing.

Until now, the glasses for stereoscopic image are not comfortable for the viewer who wears glasses for vision because the viewer has to wear the glasses for visional compensation with the glasses for stereoscopic image. Thus, it is difficult for the viewer with poor eyesight to watch the stereoscopic image because the viewer has to wear the glasses for stereoscopic image without glasses for visional compensation.

Furthermore, it is impossible to manufacture the glasses of the curved shape because transparent glass is not flexible, and the transparent glass is fragile by an impact, which means the mass production of the glasses is impossible.

FIG. 3 describes the perspective view of the glasses for stereoscopic image in prior art, where thick housing 110 and built-in cable 410 cover the glasses 105. The cable is supply of an electric signal for performing a shutter function of the glasses lens and it is connected to the left side of the housing 110. The cable 410 has a terminal 420, which is connectable to a television or the main body of a computer.

In detail, the cable 410 of the glasses for a stereoscopic image has an electric wire to connect to both polarities of a television or a main body of a computer. The cable is connected to the transparent electrode of the upper and lower glass, so that the glasses perform a shutter function by opening the glasses lens where electrical signals are supplied according to the stereoscopic image. Consequently, the viewer feels stereoscopic image by the shutter function of glasses lenses.

The glasses for stereoscopic image in prior art cannot function properly in case of occurring a situation of when a built-in electrical wire of cable 410 has a problem, causing the viewers to buy whole new products.

As shown in the FIG. 4, a block diagram of prior art glasses system in which a controller controls a shutter function of the glasses for stereoscopic image, the viewers have to wear the glasses to play a three dimensional game using a computer. Then, the glasses are electrically connected to a main body of a computer 800 by a cable 250 and a connector 251.

If stereoscopic image for a game transmitted from a main body of a computer is displayed on a monitor 700, the glasses lens performs a shutter function according to the stereoscopic image and a game player wearing the glasses 200 enjoys a game feeling the stereoscopic image.

As shown in the FIG. 5, which is a block diagram of prior art glasses system, a controller controls a shutter function of the glasses for stereoscopic image in television 900, the glasses 200 are connected to a cable 250 by a connector 251, and the connector 251 of the cable 250 is connected to a connector holder of the television 900. By shutter function, the viewer wearing the glasses 200 is able to watch stereoscopic image from broadcasts displayed on a television.

As shown in the FIG. 6, which is a block diagram of a prior art glasses system, a controller controls shutter function of the glasses for stereoscopic image, a television or a main body of a computer has a built-in driving device 300 for supplying driving signal to stereoscopic glasses in response to stereoscopic image.

A driving device 300 is composed of a control unit 320 for generating a control signal, and a liquid crystal shutter driving unit 310 for selectively supplying a liquid crystal shutter driving signal to the glasses left lens 100 or to the glasses right lens 101 of the glasses 200 on receipt of control signals from the control unit 320.

When an image is displayed to make the left glasses lens 100 open on a monitor or a television, only the left glasses lens 100 is opened by a liquid crystal shutter-driving signal in this driving device 300.

Therefore, the above liquid crystal shutter driving unit 310 does not supply a liquid crystal shutter driving signal to the right glasses lens 101 and an image is transmitted only to the left glasses lens 100, thereby making the left glasses lens 100 open. As a result, an image is passed through the left glasses lens 100.

Wherein the liquid crystal shutter-driving signal indicates an electrical signal to be supplied to the left and the right glasses lens 100 and 101.

On the contrary, an electric signal is not supplied to the right glasses lens 101 so that an image does not transmit the glasses lens 101.

Also, in case of watching stereoscopic image on television, because the glasses for stereoscopic image in prior art is connected by a wire, it has bad exterior appearance to extend a cable from a television to the glasses and the users often stumble over a cable, causing a cable malfunction.

A game player may have a wide motion when enjoying a game wearing glasses of prior art and sometimes the cable is get disconnected.

And if a cable is short, a viewer has to watch stereoscopic image by moving to a very close distance, and the viewer feels fatigue readily.

### DISCLOSURE OF INVENTION

It is an object of this invention to provide glasses lens for stereoscopic image by forming flexible lens as guiding a liquid crystal layer with a flexible transparent film layer formed on a transparent electrode.

Another object of this invention is to provide the viewer with glasses lens for stereoscopic image with thin thickness and light weight by providing a liquid crystal layer wrapped with a flexible polarizer film.

Another object of this invention is to provide glasses for stereoscopic image having protection covers.

It is another object of this invention to provide glasses for stereoscopic image a connector so that a viewer needs to purchase cable only when there is a cable malfunction.

Also the object of this invention is to provide clip-on glasses for stereoscopic image to a viewer with poor eyesight to watch clearly using fastening clip-on glasses on glasses for visional compensation.

In accord with the preceding objects, this invention is to provide glasses a system that provides method to connect between glasses and a television or a main body of a computer electrically at a separation place with a radio or IR wave.

As mentioned above, this invention comprises an upper flexible transparent film layer 51 formed on an upper transparent electrode 50, a lower flexible transparent film layer 6 formed on a lower transparent electrode 60, and a liquid crystal layer 70 formed between the upper transparent electrode 50 and said lower transparent electrode 60.

And to achieve another purpose of the invention by the preceding description; glasses of this invention comprise a upper flexible polarizer film layer 90 is formed on an upper transparent electrode 50; a lower flexible polarizer film layer 91 is formed on a lower transparent electrode 60; and a liquid crystal layer 70 is formed between the upper and lower transparent electrodes 50 and 60.

To achieve purpose of this invention, glasses for stereoscopic image comprise a pair of glasses lenses for stereoscopic image which are covered with two sheets of films formed on transparent electrodes 50 and 60, the first protection cover 130 that is covered closely with a front side of a pair of glasses lenses for stereoscopic image, the second protection cover 131 that is covered closely with a back side of a pair of lenses for stereoscopic image, a pair of units for connecting 170 and 171 to the first and the second protection covers 130 and 131 in the area except the boundary of close pressure to the glasses for stereoscopic image so that the glasses lens for stereoscopic image can not be separated from a predetermined position where the glasses lenses are covered with the first and the second protection covers 130 and 131, a plurality of units of supporting said first and second protection covers 130 and 131, and temples of a pair of glasses to be connected to said units for supporting by hinges. In addition, the connector holder portion 450 can be formed on supporting unit 180 or/and 181.

Clip-on glasses for stereoscopic image that apply to the viewer with bad eyesight comprise a pair of glasses lenses 100 and 101 for stereoscopic image which have liquid crystal layer covered by two sheets of flexible film layer that is formed on transparent electrodes 50 and 60, the first protection cover 130 covered closely with one side of a pair of glasses lens for stereoscopic image, the second protection cover 131 to be covered closely with the other side of a pair of lenses for stereoscopic image, a pair of connection units to connect, the first protection cover 130 with the second protection cover 131 except the filed of an adhesion to the first and second protection covers 130, 131 in the glasses lens, clip unit formed to the first and the second protection covers 130 and 131 to hang on glasses for visional compensation.

In this invention, the system for controlling shutter function of glasses for stereoscopic image by radio or IR wave comprises a liquid crystal shutter control device for transmitting a liquid crystal shutter control signal by radio or IR wave, a liquid crystal shutter driving device for supplying a liquid crystal shutter driving signal on the receipt of said liquid crystal shutter control signal from said liquid crystal shutter control device and a left and right lens of said glasses for selectively performing a release operation in response to said liquid crystal shutter driving signal from said liquid crystal shutter driving device.

### BRIEF DESCRIPTION OF DRAWINGS

FIG. 1a and FIG. 1b are cross-sectional views for shutter function performance of glasses for stereoscopic image in prior art.

FIG. 2 is a cross-sectional view of glasses for stereoscopic image in prior art.

FIG. 3 is a perspective view of glasses for stereoscopic image in prior art.

FIG. 4 is a block diagram that controls shutter function of glasses for stereoscopic image in computer in prior art.

FIG. 5 is a block diagram that control shutter function of glasses for stereoscopic image in television in prior art.

FIG. 6 is a block diagram that control shutter function of glasses for stereoscopic image in prior art.

FIG. 7 is a cross-sectional view of glasses lens for stereoscopic image.

FIG. 8 is another cross-sectional view of glasses lens for stereoscopic image.

FIG. 9 is a perspective view of glasses for stereoscopic image.

FIG. 10 is another cross-sectional view of glasses lens for stereoscopic image.

FIG. 11 is a perspective view of glasses using glasses lens for stereoscopic image in FIG. 10.

FIG. 12 is a perspective view of glasses for stereoscopic image that a connector holder is formed in.

FIG. 13a and FIG. 13b are lateral views of the connectors connected to the connector holder.

FIG. 14 is a view that describes glasses for stereoscopic image having a connector holder, cable and television.

FIG. 15 is a cross-sectional view of glasses for stereoscopic image that protection covers is formed.

FIG. 16 is a cross-sectional view of the protection cover portion that the linking device is formed.

FIG. 17 is a cross-sectional view of glasses lens for stereoscopic image that have protection covers.

FIG. 18 is a front view of glasses lens for stereoscopic image that have protection covers.

FIG. 19 is a perspective view of glasses for stereoscopic image that have protection covers.

FIG. 20 is a perspective view of clip-on glasses for stereoscopic image according to the first enforcement example.

FIG. 21 is a perspective view of clip-on glasses for stereoscopic image according to the second enforcement example.

FIG. 22 is a perspective view of clip-on glasses for stereoscopic image according to the third enforcement example.

FIG. 23 is a block diagram of device that control shutter function of glasses for stereoscopic image.

FIG. 24 is a block diagram to control shutter function in glasses for stereoscopic image.

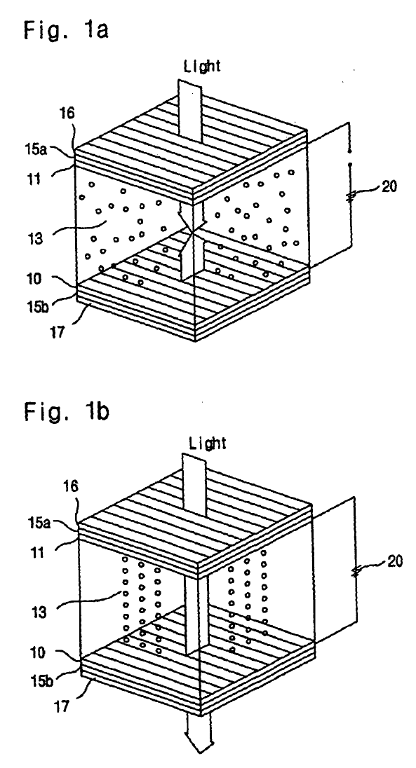

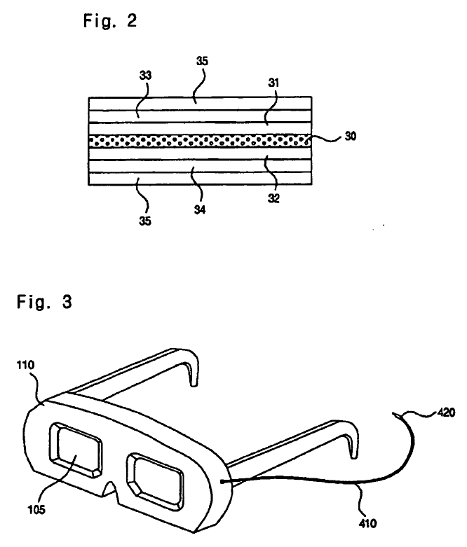

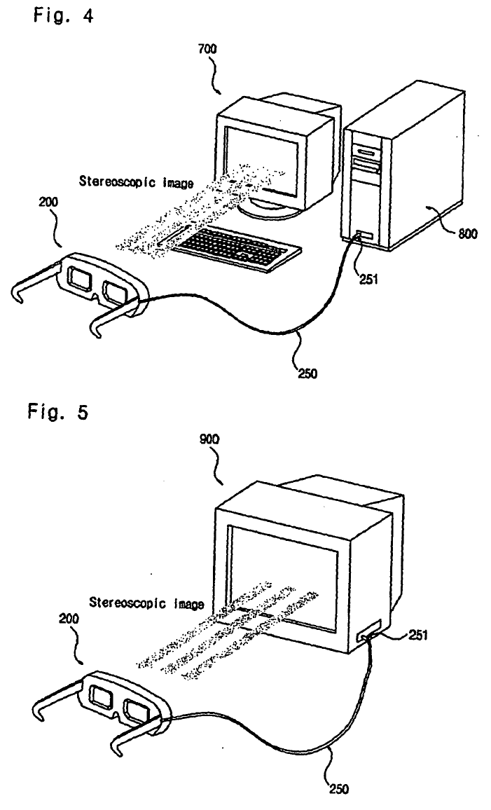

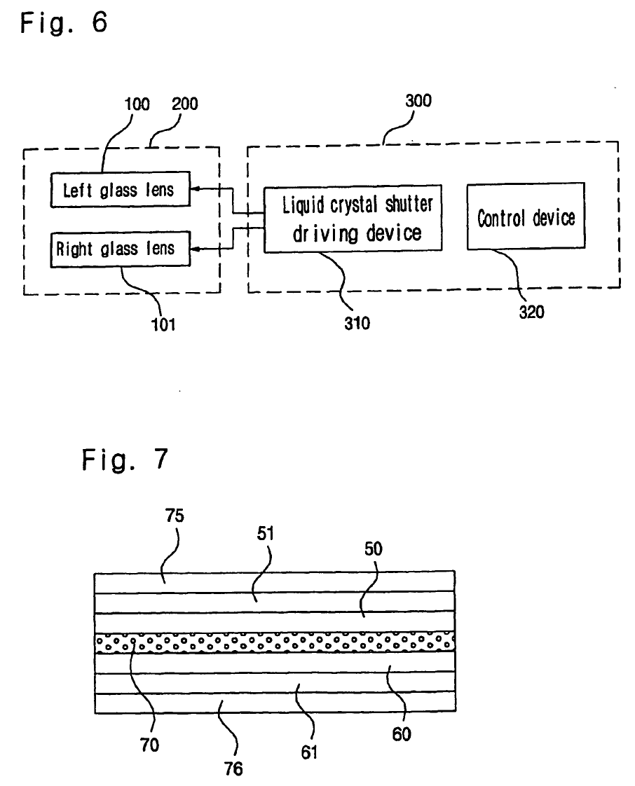

### BEST MODE FOR CARRYING OUT THE INVENTION

The best preferred embodiment of this invention would be described with the accompanying drawings.

In FIG. 7, glasses lens for stereoscopic image comprise; an upper flexible transparent film layer 51 is formed on an upper transparent electrode 50; a lower flexible transparent film layer 61 is formed on a lower transparent electrode 60; a liquid crystal layer 70 is formed between the upper transparent electrode 50 and the lower transparent electrode 60; an upper polarizer film layer 75 is formed on the upper flexible transparent film layer 51; and a lower polarizer film layer 76 is formed under the lower flexible transparent film layer 61.

The terminal is positioned at the upper and lower transparent electrode 50 and 60 to be supplied electrical signal according to stereoscopic image.

And the upper transparent electrode 50 and the lower transparent electrode 60 can be formed in the form of thin film on said upper and lower flexible transparent film layers 51 and 61.

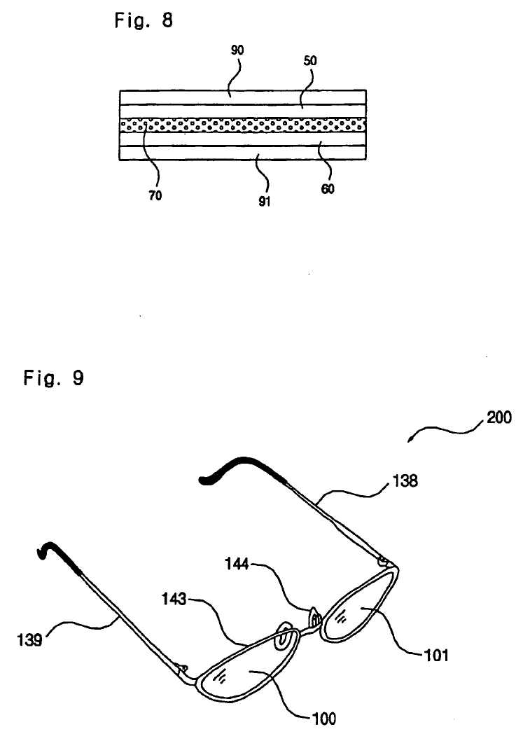

In FIG. 8, glasses lens for stereoscopic image according to this invention has the flexible transparent film layer that is polarized.

Glasses lens for stereoscopic image comprise; an upper flexible polarizer film layer 90 is formed on an upper transparent electrode 50; a lower flexible polarizer film layer 91 is formed on a lower transparent electrode 60; and a liquid crystal layer 70 is formed between the upper and the lower transparent electrodes 50 and 60.

As shown in FIG. 9, glasses for stereoscopic image comprise a pair of glasses lenses 100 and 101 which are covered with two sheets of films formed on transparent electrodes, a frame 143 which holds a pair of glasses lenses and a pair of temples 138 and 139 which are connected to the frame, and a nose rack 144 which is also connected to the frame.

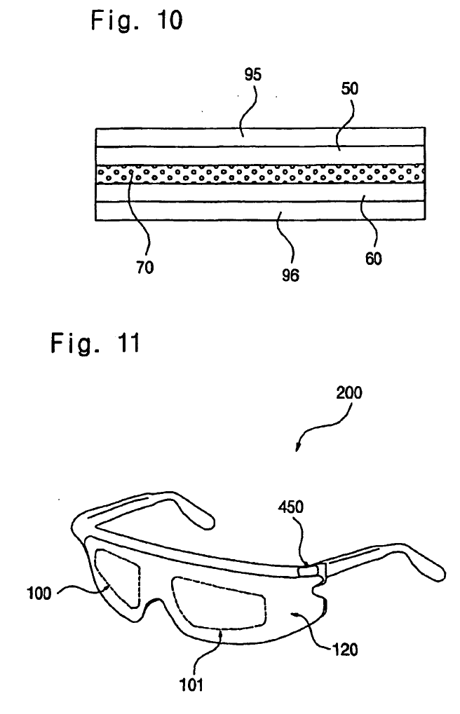

In FIG. 10, the glasses lenses protect the lenses from the outside, removing the polarization of the lens and adding the polarization to the protection cover.

Therefore, the glasses lens to be removed the polarization comprise; an upper flexible transparent film layer 95 formed on an upper transparent electrode 50; a lower transparent flexible transparent film layer 96 is formed on a lower transparent electrode 60; and a liquid crystal layer 70 is formed between the upper transparent electrode 50 and the lower transparent electrode 60.

In FIG. 11, the glasses for stereoscopic image lay on interior of the protection cover.

If glasses for stereoscopic image are manufactured using the glasses lens of this invention, the glasses can be made more fashionable because the glasses having curved shape can be manufactured by flexible lenses, and a viewer wearing the glasses feels more comfortable because the frame of the glasses is thin and light.

In prior art of glasses lenses for stereoscopic image, only the curved glasses with quadrilateral shape are made using the kind of a glass. In case the curved glasses according to this invention using methods in which flexible film layer is cut, it is easier to make various shapes of circumference surface such as a polygon, a curved-shape, and a quadrilateral shape.

And glasses 200 for stereoscopic image include a connector holder portion 450, which receives an electrical signal so that a shutter function is performed with receipt of stereoscopic image. Therefore, glasses for stereoscopic image according to this invention are made with lenses using a flexible film layer and the glasses for stereoscopic image equipped with a connector holder.

In detail, glasses according to this invention have protection cover supporting portions 180 and 181 on outside surface of protection cover 120 of glasses, and connector holder portion 450 in the protection cover support portion.

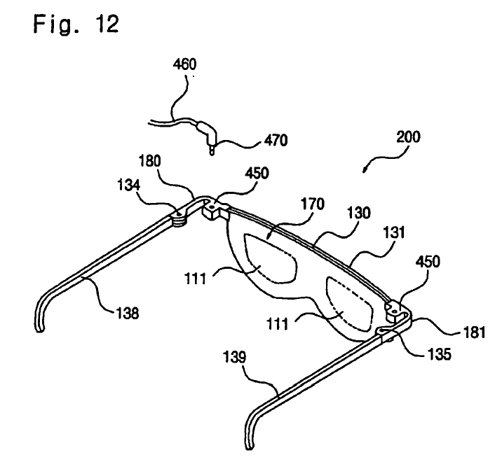

In FIG. 12, a perspective view of glasses for stereoscopic image has the connector holder portion, the glasses comprise a pair of glasses lenses 111 which are covered by two sheets of films formed on transparent electrodes, the first protection cover 130 to be covered closely with one side of a pair of glasses lenses, the second protection cover 131 to be covered closely with the other side of a pair of glasses lenses; connection unit to connect the first protection cover 130 with the second protection cover 131 except the field of an adhesion to the first and second protection covers 130 and 131 in the glasses lens; the protection cover support portions 180 and 181 fasten the first and second protection covers 130 and 131 by covering closely the flank of the first and second protection cover 130 and 131; and the temple 138 and 139 to be connected the extending portion of the protection cover support portion by hinges 134 and 135.

If the connector holder portion 450 is formed on the protection cover, the connector holder supports portions 180 and 181 between hinges 134 and 135, and the protection covers 130 and 131, the connector 470 of the cable which is separately from the glasses easily is inserted to the holder 450 and is easily linked.

And for connection unit 170, using glue is preferred and recommended. More preferably, connection unit 170 may includes all other connection units by which the first and second protection covers 130 and 131 can be linked, so that glasses lens 111 may not be separated from a predetermined position.

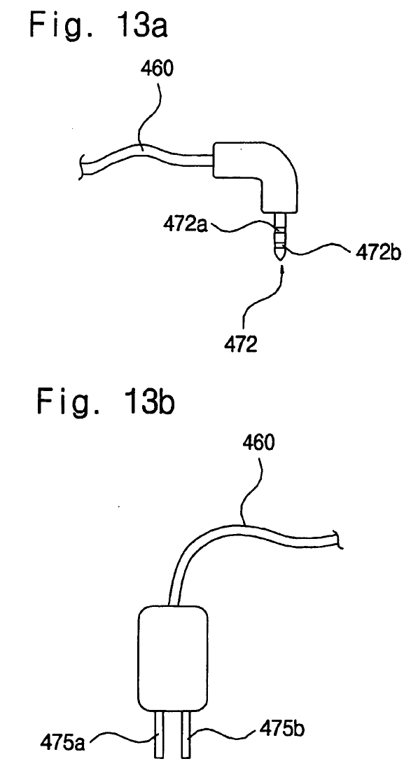

FIG. 13a and FIG. 13b are lateral view of connector holder. According to this invention, the shape of the connector 472 connected to the cable 460 in FIG. 13a is a rod. And an independent pair of ring electrodes 472a and 472b is formed on the rod.

A pair of ring electrodes 472a and 472b formed on connector 472 is connected electrically to two electric wires of cable 460, which are connected to both polarity terminal of television or main body of a computer.

And the connector holder portion 450 has an accommodation hole for connector 472, the accommodation hole has a pair of ring electrodes which corresponds to ring electrodes 472a and 472b aforementioned, and the ring electrodes are able to carry out shutter function as being connected the electrodes of flexible substrate to be formed on glasses lens.

As shown in FIG. 13b, the connector has + terminal 475a and − terminal 475b separately.

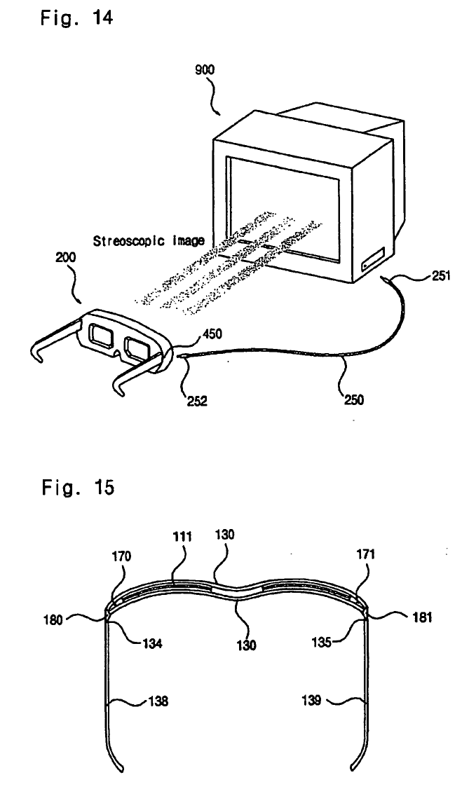

FIG. 14 shows a connection state of glasses for stereoscopic image having connector holder with a cable and television, glasses 200 have a connector holder 450, and if the connector holder 450 is connected to the connector of one side 252 of the cable 250 and the connector of the other side 251 is connected to the connector holder of television 900, the viewers wearing the glasses can watch stereoscopic image.

This invention provides glasses for stereoscopic image unnecessary to change into whole new glasses, but only need to change into a new cable in case of cable malfunction.

In FIG. 15, a cross-sectional view of glasses for stereoscopic image, the first and second protection covers 130 and 131 is wrapping the left and the right glasses lenses 100 and 101 and the flank of the first and second protection cover are fixed by connection unit 170 and 171.

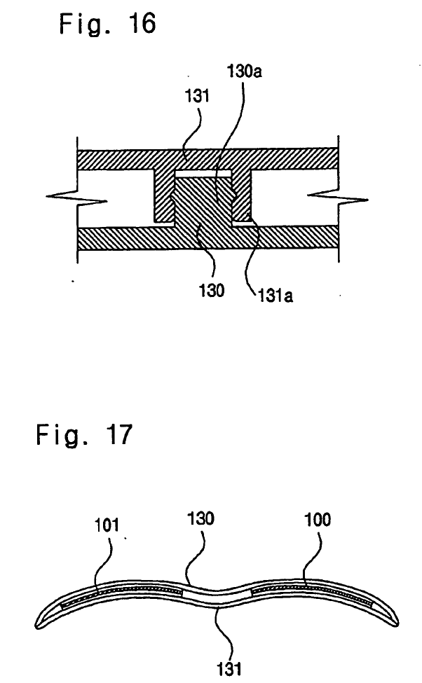

As shown in FIG. 16, the connection unit can be made in shape of convex and concave 130a and 131a. Then, the convex 130a is formed on the first protection cover 130 as an integrated body and the concave 131a is formed on the second protection cover 131 as an integrated body.

And then the convex 130a and the concave 131a is formed along with the outer side of the first and second protection covers 130 and 131 or along the outer side of the left and right glasses lenses 100 and 101 to fix the lenses firm.

And the connection unit can be put together with the first and the second protection covers by using glue.

The support portion of the protection covers 180 and 181 can be connected to the temple, and be formed hinge on the support portion of the protection covers 180 and 181 (FIG. 12) to fold the temple.

FIG. 17 shows a cross-sectional view of glasses for stereoscopic image with the protection cover, the first protection cover 130 covers one side of a pair of glasses lens 100 and 101. The second protection cover 131 covers the other side of a pair of glasses lens. The first and second protection covers 130 and 131 except the field of the glasses lenses adhered.

The first and second protection covers 130 and 131 fix glasses lenses 100 and 101 for stereoscopic image and protects them from external dirt and materials.

As shown in FIG. 7, if glasses for stereoscopic image do not have the polarization, the glasses can be made by sticking the polarized film layer on the first and the second protection covers 130 and 131.

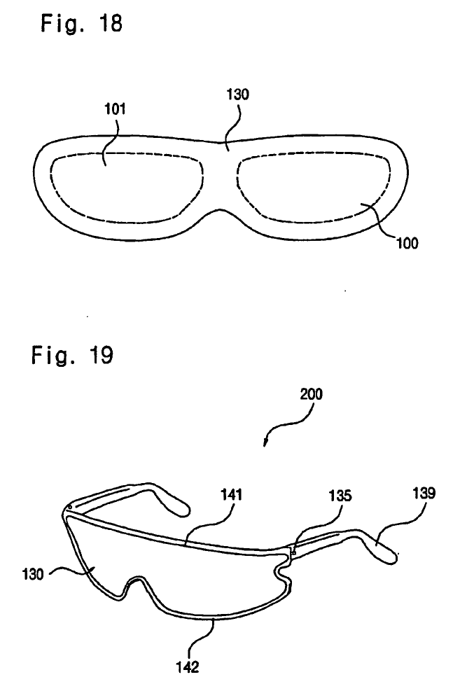

According to FIG. 18, a front view of glasses for stereoscopic image with protection cover, the first protection cover 130 is formed as an integrated body and covers the left and the right glasses lens 100 and 101. Of course, the first and the second protection cover is the same size.

And the left and the right glasses lenses 100 and 101 are separated from each other so that visual field of a person wearing the glasses is conformed to the lens' surface.

According to FIG. 19, which is a perspective view of glasses for stereoscopic image, lower part of the first and second protection covers 130 and 131 are formed of a ‘W’ shape and the ‘W’ shape is supported by lower frame 142 and the upper part of ‘W’ shape is supported by an upper frame 141.

Electrode lines to be connected with transparent electrode in the left and the right glasses lenses have a connector that a shutter control signal can be transmitted from outside by the through hole formed inside the upper frame 141.

Besides, various methods for connector can be used.

By adding a clip member except the first and the second protection cover 130 in FIGS. 19, 20, 21 on the first and the second protection cover 130 and 131 to fix on glasses for vision, clip-on glasses for stereoscopic image is formed.

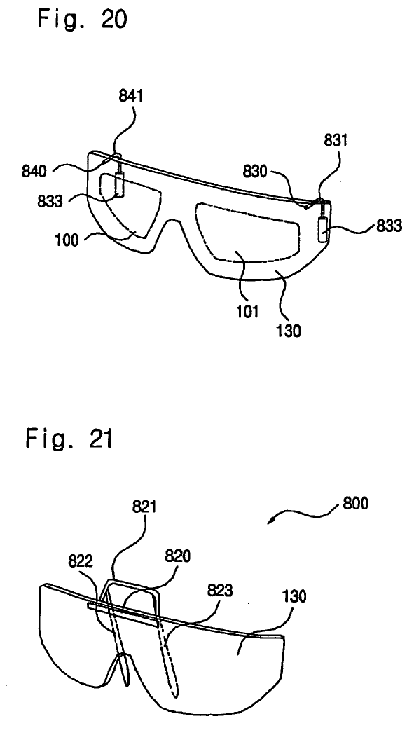

According to FIG. 20, a perspective view of clip-on glasses for stereoscopic image, clip-on glasses have the first and second fixed portions 830 and 840 to be installed on the upper part of the protection cover 130 having glasses lenses within, the first and the second L-shaped racks 831 and 841 that are extended from the first and the second fixed portion 830 and 840 to hang on glasses for visional compensation, and the pressure rod 833 that is connected to the first and second L-shaped rack is to stick on the glasses for stereoscopic image. The viewer with bad eyesight also can see the stereoscopic image well using the clip-on type of glasses for the stereoscopic image.

In FIG. 21 that is perspective view of one of clip-on glasses for stereoscopic image, the clip-on glasses for stereoscopic image have fixed portion 820 to be installed on the upper part of the first protection cover 130 having glasses lenses within, connection member 821 that connection member on one side of fixed portion connected to the other side of fixed portion by bending and the first and second racks 822 and 823 to be connected to the upper part of connection member 821 to hang on glasses for visional compensation. And then the clip-on glasses for stereoscopic image may have the pressure rod to press on the protection cover.

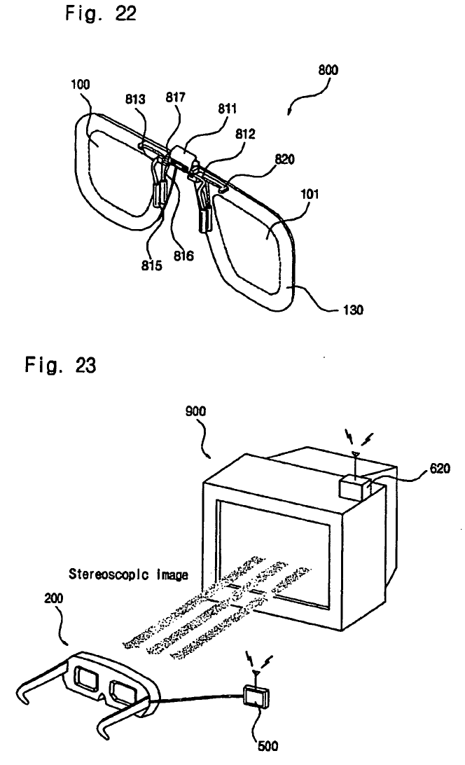

In FIG. 22, a perspective view of clip-on glasses for stereoscopic image, the clip-on glasses for stereoscopic image have fixed portion 820 to be installed on the upper part of the protection cover 130 to be separated from each other having glasses lens within, a pair of outer racks 816 to be contacted with one side of glasses extending from the fixed portion 820, a guide rod 812 to lay on the fixed portion 820, a pair of inner racks 813 to be connected to both sides of guide rod and to contact to the other side of glasses, and pressure member 811 pressurize the spring 817 to be formed on guide rod 812 to make a pair of inner racks 813 move.

In this clip-on glasses for stereoscopic image, when the viewer pressurize the pressure member 811, a pair of inner racks 813 is separated from a pair of outer racks and glasses for vision between inner rack 813 and outer rack 816 are inserted. Then, it is to make the pressure member loosen. Outer rack 816 is contacted with one side of glasses lens for visional compensation and inner rack 813 is contacted to its other side.

Therefore, the clip-on glasses for stereoscopic image can be fixed with hanging glasses for visional compensation.

If the pressure rod 815 is formed to the inner and outer rack 813 and 816, the clip-on glasses for stereoscopic image can be fixed firmly to the glasses for visional compensation.

And a connector holder and a cable that is connected to the electrode of glasses lens, may be formed to the fixed portion 810.

Explanation upon examples about shutter function adjustment system and method of glasses for solid reflex using radio communication is as follows.

In FIG. 23, a block diagram to control shutter function of glasses for stereoscopic image, the liquid crystal shutter control signal is transmitted from RF or IR transmitting part 620 of television 900, the liquid crystal shutter driving device 500 receive the liquid crystal shutter control signal, and the left and the right parts of glasses lenses 100 and 101 are opened selectively.

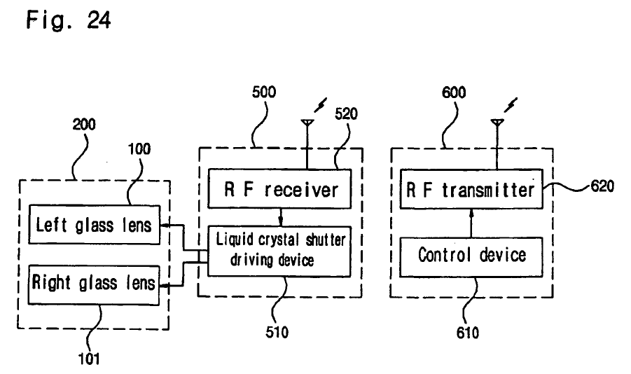

In FIG. 24, a block diagram to control shutter function of glasses for stereoscopic image, television or main body of a computer with the liquid crystal shutter control device 600 transmits the liquid crystal control signal by radio according to stereoscopic image.

The liquid crystal control device 600 has a control part 610 that generates the control signal by stereoscopic image and RF transmitter 620 that transmits by radio to receive the control signal from the control part 610. And the control signal to generate from RF transmitter 620 by radio receive from the liquid crystal shutter driving device 500 and supply the liquid crystal driving signal selectively to the left and the right glasses lens 101.

Here the liquid crystal driving device 500 comprise the RF receiver 520 to receive the radio control signal from the RF transmitter 620 and the liquid crystal shutter driving part 520 to transmit the liquid crystal driving signal to the left or right glasses lens 100 and 101 by a control signal from RF receiver 520.

RF receiver 520 and RF transmitter 620 are used within the standard short range of radio communication so that a short range radio communication can be carried out between the liquid crystal driving device 500 and the liquid crystal shutter control device 600 in the television or main body of a computer without trouble.

According to this invention, the liquid crystal driving device 500 is manufactured about a pocket size so that it can be put into a pocket and when a game player has a wide motion during the game, the game player can move freely. When subject of a meeting is appeared with stereoscopic image, a person is free from a cable.

Glasses lens for a stereoscopic image and glasses using the same guide a liquid crystal layer with flexible films formed on the transparent electrode. This makes the lens flexible and fashionable by bending the lens.

In this invention, a film's breakage is shortened because its material is unbreakable by impact and the viewer wearing the glasses is comfortable because of thin thickness and lightweight.

People with the bad eyesight can see the stereoscopic image well, when using the clip-on glasses for the stereoscopic image.

The invention can remove some problems that might occur due to cable, and the viewer wearing the glasses can watch the stereoscopic image wherein the viewer can move freely by controlling the liquid crystal shutter-driving signal that is transmitted at the separation place from the viewer and the television or the computer.

The foregoing description was set forth for illustrative purposes only. Variations, within the scope of the appended claims, may become apparent to those skilled in the art.

1. Glasses lens for stereoscopic image comprising:
an upper flexible transparent film layer formed on an upper transparent electrode;
a lower flexible transparent film layer formed on a lower transparent electrode; and
a liquid crystal layer formed between said upper and lower transparent electrodes.

2. Glasses lens for stereoscopic image as defined in claim 1, while further comprising:
an upper polarizer film layer formed on said upper flexible transparent film layer; and
the lower polarizer film layer formed on said lower flexible transparent film layer.

3. Glasses for stereoscopic image comprising:
an upper flexible polarizer film layer formed on an upper transparent electrode;
a lower flexible polarizer film layer formed on a lower transparent electrode; and
a liquid crystal layer formed between said upper and lower transparent electrodes.

4. Glasses for stereoscopic image comprising:
a pair of glasses lenses which are covered with two sheets of films formed on transparent electrodes;
a frame which holds a pair of said glasses lenses;
a temple which is connected to said frame; and
a nose rack which is connected to said frame.

5. Glasses for stereoscopic image as claimed in claim 4, wherein a pair of said glasses lenses comprise:
an upper flexible transparent film layer formed on an upper transparent electrode;
a lower flexible transparent film layer formed on a lower transparent; and
a liquid crystal layer formed between said upper and lower transparent electrodes.

6. Glasses for stereoscopic image as claimed in claim 5 while further comprising:
an upper polarizer film layer formed on said upper flexible transparent film layer; and
a lower polarizer film layer formed on said lower flexible transparent film layer.

7. Glasses for stereoscopic image as claimed in claim 4, wherein a pair of said glasses lenses comprising:
an upper flexible polarizer film layer formed on an upper transparent electrode;
a lower flexible polarizer film layer formed on a lower transparent electrode; and
a liquid crystal layer formed between said upper and lower transparent electrodes.

8. Glasses for stereoscopic image comprising:
a pair of glasses lenses comprising a liquid crystal layer to be covered with two sheets of flexible films formed on transparent electrodes;
a first protection cover to be closely covered with a front side of a pair of glasses lenses;
a second protection cover to be closely covered with a back side of a pair of glasses lenses;
a pair of means for connecting to said first protection cover to second protection cover in a region except the boundary of close pressure to said glasses for stereoscopic image so that glasses lenses for stereoscopic image cannot be separated from a predetermined position at which said glasses lenses are covered with said first and second protection covers;
a plurality of means for supporting said first and second protection covers of which one sides are respectively fastened by the close pressure; and
a temple to be connected to a plurality of said means for supporting by hinges.

9. Glasses for stereoscopic image as claimed in claim 8, further comprising:
connector holder portion respectively formed to said supporting means, for accommodating their connector terminals into which an electrical signal is flowed according to a stereoscopic image in order to carry out a shutter function.

10. Glasses for stereoscopic image as claimed in claim 8 or claim 9, further comprising:
hinges for linking a plurality of said supporting means to said temple so that said temple can be turn on the basis of the plurality of said supporting means.

11. Glasses for stereoscopic image as claimed in claim 8, wherein said connecting means comprises both a convex and concave, said convex being formed on said the first protection cover as an integrated body, and said concave being formed on said second protection cover as an integrated body.

12. Glasses for stereoscopic image as claimed in claim 8, wherein said connecting means is preferably a glue.

13. Glasses for stereoscopic image as claimed in claim 9,
wherein said connector holder portion has a corresponding hole to accommodate the connector terminals at which an electrode is formed in order to connect electrically to the corresponding connector terminals.

14. Glasses for stereoscopic image as claimed in claim 8, wherein a pair of said glasses lenses for stereoscopic image comprise:
an upper flexible transparent film layer formed on a transparent electrode;
a lower flexible transparent film layer formed on a transparent electrode; and
a liquid crystal layer formed between said upper and lower transparent electrodes.

15. Glasses for stereoscopic image as claimed in claim 14,
wherein said glasses for stereoscopic image further include an upper polarizer film layer formed on said upper flexible transparent film layer and a lower polarizer film layer formed under said lower flexible transparent film layer.

16. Glasses for stereoscopic image as claimed in claim 8,
wherein said upper and lower polarizer film layers are respectively formed on said corresponding first and second protection covers.

17. Glasses for stereoscopic image as claimed in claim 8,
wherein a shape of said glasses for stereoscopic image is a polygon or a curved shape in view of an outward circumference.

18. Glasses for stereoscopic image, wherein said glasses for stereoscopic image are clip-on glasses for stereoscopic image, comprising:
a pair of glasses lenses comprising a liquid crystal layer to be covered with two sheets of flexible film formed on transparent electrodes;
a first protection cover to be covered closely with one side of a pair of glasses lenses to be separated from each other;
a second protection cover to be covered closely with the other side of a pair of said glasses lenses to be separated from each other;
a connection means for adhering said first protection cover with said second protection cover in order to fix a pair of glasses for stereoscopic image; and
a means for clipping which is formed on said first and second protection covers to hang on glasses for visional compensation.

19. Glasses for stereoscopic image as claimed in claim 18,
wherein said means for clipping comprises first and second fixed portions to be installed on upper parts of said first and second protection covers and first and second L-shaped racks that are extended from said first and second fixed portions in order to hang on glasses for visional compensation.

20. Glasses for stereoscopic image as claimed in claim 18, wherein said means for clipping comprises:
first and second fixed portions to be installed on upper parts of said first and second protection covers;
a connection member of which one side of each first and second fixed portion is connected with the corresponding other side of each first and second fixed portion by bending; and
first and second racks for being connected to an upper part of connection member in order to hang on glasses for visional compensation.

21. Glasses for stereoscopic image as claimed in claim 19
wherein said clip-on glasses include a pressure rod to adhere on said first and second L-shaped racks.

22. Glasses for stereoscopic image as claimed in claim 18, wherein said upper and lower polarizer film layers are respectively formed on said corresponding first and second protection covers.

23. Glasses for stereoscopic image as claimed in claim 18, wherein a pair of said glasses lenses comprise:
an upper flexible transparent film layer formed on an upper transparent electrode;
a lower flexible transparent film layer formed on a lower transparent electrode; and
a liquid crystal layer that is formed between said upper and said lower transparent electrodes.

24. Glasses for stereoscopic image as claimed in claim 18,
wherein said clip-on glasses have a connector holder for being connected to electrode terminals or a cable in order to provide an electrical signal for shutter function.

25. Glasses for stereoscopic image, wherein said glasses for stereoscopic image are clip-on glasses for stereoscopic image, comprising:
a pair of glasses lenses comprising a liquid crystal layer to be covered with two sheets of flexible films formed on transparent electrodes;
a pair of protection covers for being separated from each other;
a fixed portion for being fixed on upper parts of said first and second protection covers;
a pair of outer racks for being contacted with one side of glasses which is extended from said fixed portion;
a guide rod for being installed on said fixed portion;
a pair of inner racks for being respectively connected to both sides of said guide rod and for being contacted with the other side of glasses for visional compensation; and
a means for pressurizing a spring formed on said guide rod in order to inner rack be moved.

26. System, wherein said system uses glasses for stereoscopic image for controlling shutter function thereof by wireless communication, comprising:
a liquid crystal shutter control device for transmitting a liquid crystal shutter control signal by wireless communication in response to kinds of stereoscopic image;
a liquid crystal shutter driving device for supplying a liquid crystal shutter driving signal on the receipt of said liquid crystal shutter control signal from said liquid crystal shutter control device; and
left and right lenses of said glasses for selectively performing an open operation in response to said liquid crystal shutter driving signal from said liquid shutter driving device.

27. System using glasses for stereoscopic image as claimed in claim 26,
wherein said liquid crystal control device has a control part for generating said liquid crystal shutter control signal and a transmitter for transmitting said liquid crystal shutter control signal by radio.

28. System using glasses for stereoscopic image as claimed in claim 26,
wherein said liquid crystal shutter driving device includes a receiver for receiving said liquid crystal shutter control signal from said transmitter and a liquid crystal shutter driving part for selectively transmitting said liquid crystal shutter driving signal to left or right lens of said glasses in response to said liquid crystal shutter control signal from said receiver.

29. System using glasses for stereoscopic image as claimed in claim 26, said glasses comprising:
said left and right lenses of said glasses comprising a liquid crystal layer to be covered with two sheets of films formed on transparent electrodes;
a first protection cover to be covered closely with one side of a pair of glasses lenses;
a second protection cover to be covered closely with the other side of a pair of glasses lenses;
a pair of means for connecting said first protection cover to said second protection cover in a region except the boundary of close pressure to said glasses for stereoscopic image so that glasses lens for stereoscopic image cannot be separated from a predetermined position at which said glasses lens is covered with said first and second protection covers;
a plurality of means for supporting fastening said the first and second protection covers by covering their flank; and
a temple to be connected to a plurality of means for supporting by hinges.

30. System using glasses for stereoscopic image as claimed in claim 29, said glasses including a hinge for linking said means for supporting to said temple in order to fold said temple on basis of any axis.

31. Method, wherein said method uses glasses for stereoscopic image for controlling shutter function thereof by wireless communication, said method for processing comprising the steps of:
transmitting a liquid crystal shutter control signal in a liquid crystal shutter control device by wireless communication in response to kinds of stereoscopic image;
supplying a liquid crystal shutter driving signal in a liquid crystal shutter driving device on the receipt of said liquid crystal shutter control signal from said liquid crystal shutter control device; and
selectively performing an open operation a left and right lenses of said glasses in response to said liquid crystal shutter driving signal from said liquid crystal shutter driving device.
